(19) United States
(12) Patent Application Publication
(10) Pub. No.: US 2006/0146568 A1
(43) Pub. Date: Jul. 6, 2006

(54) Backlight module and liquid crystal display using the same

(75) Inventor: Wu-Hong Fang, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/246,762

(22) Filed: Oct. 6, 2005

(30) Foreign Application Priority Data
Dec. 30, 2004 (CN) 200410091949.3

(51) Int. Cl. F21V 7/04

(52) U.S. Cl. 362/612

(57) ABSTRACT

A liquid crystal display device (4) includes a liquid crystal display panel (41) and a backlight module (2) opposite to the liquid crystal display panel. The backlight module includes a light guide plate (20) and a point light source (21) adjacent to the light guide plate. A horizontal central axis (210) of the point light source and a horizontal central axis (200) of the light guide plate are on a same plane. The backlight module can further comprises a prism sheet, a diffusing sheet, a reflective sheet, and/or a polarizer. The liquid crystal display device can provide a uniform display effect.

### BACKGROUND OF THE INVENTION

1. Field of the Invention

The present invention relates to a backlight module and a liquid crystal display (LCD) using the same.

2. General Background

Liquid crystal displays are commonly used as display devices for compact electronic apparatuses because they not only provide good quality images with little power, but also are very thin. The liquid crystals in a liquid crystal display do not emit any light themselves. The liquid crystals have to be lit by a light source so as to clearly and sharply display text and images. Thus, a backlight module for an LCD is generally needed.

A typical backlight module is shown in FIG. 4. The backlight module 1 includes a light guide plate (LGP) 10 and a light source 11. The LGP 10 includes a light incident surface 12, and a light emitting surface 13 adjacent to the light incident surface 12. The light source 11 is typically a light emitting diode (LED) adjacent to the light incident surface 12 of the LGP 10. A horizontal central axis of the LED 11 and a horizontal central axis of the LGP 10 are not on a same plane. Rather, the horizontal central axis of the LED 11 is lower than the horizontal central axis of the LGP 10. Light beams from the LED 11 enter the LGP 10 through the light incident surface 12, are reflected within the LGP 10, and are finally emitted out from the light emitting surface 13 of the LGP 10.

The light beam emit from the LED 11 over a certain range of angles of divergence, due to limitations inherent in the structure of the LED 11 itself. In general, most of the light beam are concentrated around the horizontal central axis of the LED 11, while relatively little light beam project at angles far from the horizontal central axis of the LED 11. Thus, the brightness below the horizontal central axis of the LGP 10 is greater than the brightness above the horizontal central axis of the LGP 10, which results in the backlight module 1 providing a non-uniform display.

What is needed, therefore, is a backlight module that can provide uniform light. What is also needed is a liquid crystal display device that can provide a uniform display.

### SUMMARY

In one preferred embodiment, a backlight module for a liquid crystal display device includes a light guide plate and a point light source adjacent to the light guide plate. A horizontal central axis of the point light source and a horizontal central axis of the light guide plate are on a same plane. The backlight module can provide uniform light.

In another embodiment, a liquid crystal display device includes a liquid crystal display panel and a backlight module for illuminating the liquid crystal panel. The backlight module includes a light guide plate and a point light source adjacent to the light guide plate. A horizontal central axis of the point light source and a horizontal central axis of the light guide plate are on a same plane. The liquid crystal display device can provide a uniform display effect.

Other advantages and novel features will become more apparent from the following detailed description of preferred embodiments when taken in conjuction with the accompanying drawings, in which:

### BRIEF DESCRIPTION OF THE DRAWINGS

FIG. 1 is a schematic, side plan view of a backlight module according to a first embodiment of the present invention;

FIG. 2 is a schematic, top plan view of a backlight module according to a second embodiment of the present invention;

FIG. 3 is a schematic, side plan view of a liquid crystal display device incorporating the backlight module of FIG. 1; and

FIG. 4 is a schematic, side plan view of a conventional backlight module.

### DETAILED DESCRIPTION OF PREFERRED EMBODIMENTS

Reference will now be made to the drawings to describe the preferred embodiments in detail.

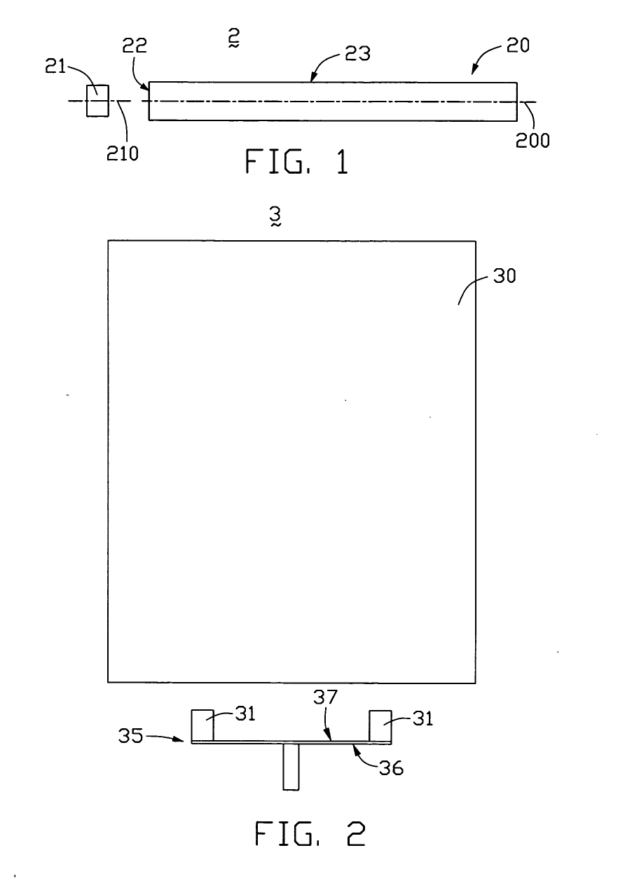

Referring to FIG. 1, a backlight module 2 according to a first embodiment of the present invention includes an LGP 20 and a point light source 21. The LGP 20 includes a light incident surface 22, and a light emitting surface 23 adjacent to the light incident surface 22. The point light source 21 is an LED 21 adjacent to the light incident surface 22. A horizontal central axis 210 of the LED 21 and a horizontal central axis 200 of the LGP 20 are on a same plane. A height of the LED 21 is less than a thickness of the LGP 20, and a distance between the LED 21 and LGP 20 is less than 1×10⁻⁴ meters.

Because the horizontal central axis 210 of the LED 21 and the horizontal central axis 200 of the LGP 20 are on the same plane, light beams from the point light source 21 enter the LGP 20 through the light incident surface 22 such that the brightness below the horizontal central axis 200 of the LGP 20 is the same as the brightness above the horizontal central axis 200 of the LGP 20. This enables the backlight module 2 to provide a uniform display.

FIG. 2 shows a backlight module 3 according to a second embodiment of the present invention. The backlight module 3 is similar to the backlight module 2 of the first embodiment. However, the backlight module 3 comprises a light source 35, which includes two LEDs 31. The light source 35 is arranged on a flexible printed circuit (FPC) 36. The FPC 36 includes a reflective layer 37 attached thereon, for reflecting light to an LGP 30 located adjacent to the LEDs 31. The FPC 36 can supply power to the LEDs 31, thereby reducing wire connections and resulting in lower power consumption. The reflective layer 37 of the FPC 36 can help reflect some light emitted from the LEDs 31 back to the LGP 30, thereby improving the light utilization rate and the brightness of the backlight module 3.

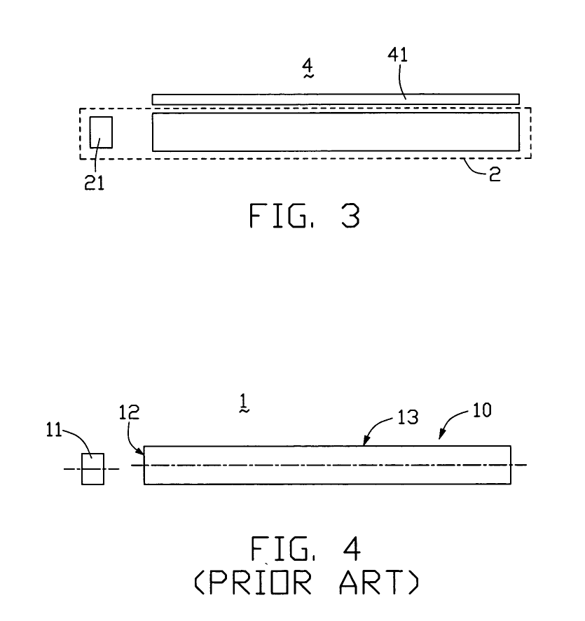

Referring to FIG. 3, a liquid crystal display device 4 according to a third embodiment of the present invention includes a liquid crystal display panel 41 and the backlight module 2. Light beams from the point light source 21 enter the LGP 20, are emitted from the light emitting surface 23, and propagate to the liquid crystal panel 41. Liquid crystals (not shown) in the liquid crystal panel 41 are lit up by the light beams, whereby the liquid crystal display device 4 can clearly and uniformly display text and images.

In alternative embodiments, the height of the LED 21 or LEDs 31 can be the same as the thickness of the LGP 20, 30. The backlight module 2, 3 can further include a prism sheet, a diffusing sheet, a reflective sheet, and/or a polarizer.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A backlight module for a liquid crystal display, comprising:
a light guide plate; and
a point light source adjacent to the light guide plate, wherein a horizontal central axis of the point light source and a horizontal central axis of the light guide plate are on a same plane.

2. The backlight module as claimed in claim 1, wherein the point light source is a light emitting diode.

3. The backlight module as claimed in claim 1, wherein the light guide plate comprises a light incident surface adjacent to the point light source.

4. The backlight module as claimed in claim 1, wherein a distance between the point light source and the light guide plate is less than 1×10⁻⁴ meters.

5. The backlight module as claimed in claim 1, wherein a height of the point light source is equal to a thickness of the light guide plate.

6. The backlight module as claimed in claim 1, wherein a height of the point light source is less than a thickness of the light guide plate.

7. The backlight module as claimed in claim 1, wherein the point light source is arranged on a flexible printed circuit.

8. The backlight module as claimed in claim 7, wherein the flexible printed circuit comprises a reflective layer.

9. A liquid crystal display device, comprising:
a liquid crystal display panel; and
a backlight module for illuminating the liquid crystal display panel, the backlight module comprising a light guide plate and a point light source adjacent to the light guide plate, wherein a horizontal central axis of the point light source and a horizontal central axis of the light guide plate are on a same plane.

10. The liquid crystal display device as claimed in claim 9, wherein the point light source is a light emitting diode.

11. The liquid crystal display device as claimed in claim 9, wherein the light guide plate comprises a light incident surface adjacent to the point light source.

12. The liquid crystal display device as claimed in claim 9, wherein a distance between the point light source and the light guide plate is less than 1×10⁴ meters.

13. The liquid crystal display device as claimed in claim 9, wherein a height of the point light source is equal to a thickness of the light guide plate.

14. The liquid crystal display device as claimed in claim 9, wherein a height of the point light source is less than a thickness of the light guide plate.

15. The liquid crystal display device as claimed in claim 9, wherein the point light source is arranged on a flexible printed circuit.

16. The liquid crystal display device as claimed in claim 15, wherein the flexible printed circuit comprises a reflective layer.

17. A liquid crystal display device comprising:
a liquid crystal display panel; and
a backlight module for illuminating the liquid crystal display panel, the backlight module comprising a light guide plate defining an incident surface and an emitting surface which is perpendicular to said incident surface and defines a primary surface of the light guide plate, said emitting surface defining a direction perpendicular thereto, and a light source located beside said incident surface in confrontation, wherein the light guide plate dimensioned different from the light source along said direction, and a horizontal central axis of the light source and a horizontal central axis of the light guide plate with regard to said direction are both on a same horizontal plane perpendicular to said direction.

18. The liquid crystal display device as claimed in claim 17, wherein said light guide plate is dimensioned larger than the light source along said direction.

19. The liquid crystal display device as claimed in claim 17, wherein said light source is a point light source.
